(19) United States
(12) Patent Application Publication
(10) Pub. No.: US 2006/0251425 A1
(43) Pub. Date: Nov. 9, 2006

(54) Suppression of fiber-induced noise caused by narrow linewidth lasers

(75) Inventors: Vladimir Kupershmidt, Pleasanton, CA (US); Henry Plaessmann, San Jose, CA (US); John Major, San Jose, CA (US); Sabeur Siala, Sunnyvale, CA (US)

Correspondence Address: MICHAELSON & ASSOCIATES, P.O. BOX 8489, RED BANK, NJ, 07701, US

(73) Assignee: K2 OPTRONICS, Sunnyvale, CA (US)

(21) Appl. No.: 11/316,700

(22) Filed: Dec. 22, 2005

Related U.S. Application Data
(60) Provisional application No. 60/638,679, filed on Dec. 23, 2004.

(51) Int. Cl. H04B 10/12

(52) U.S. Cl. 398/147

(57) ABSTRACT

The present invention relates to the suppression of nonlinear fiber effects leading to optical noise, particularly Stimulated Brillouin Scattering (SBS), when narrow linewidth light sources are used in optical communication systems, particularly external cavity laser light sources. Various intra-cavity and extra-cavity modulation techniques are described that broaden the output of the laser light source so as to distribute the laser energy among multiple spectral lines and not exceed the SBS threshold. Thermal, mechanical and electrical modulation techniques are described.

### CROSS REFERENCE TO RELATED APPLICATIONS

This application claims priority from the following co-pending patent applications: provisional patent application Ser. No. 60/638,679 filed Dec. 23, 2004; patent application Ser. No. 11/097,745 filed Apr. 1, 2005; patent application Ser. No. 11/097,746 filed Apr. 1, 2005, pursuant to one or more of 35 U.S.C. §119, §120, §365. The entire contents of all cited patent applications and provisional patent applications are incorporated herein by reference for all purposes.

### BACKGROUND OF THE INVENTION

1. Field of Invention

This invention relates generally to the field of optical communications and, more particularly, to the suppression of noise in optical transmissions through fibers.

2. Description of the Prior Art

Optical communication systems are typically based on modulating a light beam in accordance with the information to be transmitted and sending this modulated light beam through a single mode fiber (SMF) to an optical receiver at the far end of the fiber link. Present communication systems typically operate with a light beam having a wavelength in the region of approximately 1310 nm (nm=nanometer=10⁻⁹ meter) or in the region of approximately 1550 nm. The transmission of high-bandwidth analog and digital modulated signals usually dictates the use of narrow linewidth lasers.

Optical wavelengths in the 1550 nm region have been widely deployed in telecommunication and cable TV (CATV) high-bandwidth applications chiefly because of the following reasons:

(i) low signal attenuation in standard SMFs when transmitting light having wavelengths around 1550 nm (typical attenuations can be around 0.25 dB/km, decibels per kilometer);

(ii) the availability of efficient optical amplifiers (such as erbium-doped fiber amplifiers, EDFAs) for signal amplification of optical carriers around 1550 nm up to saturated output powers exceeding about 23 dBm (200 mW). This enables longer reach fiber links and the ability to optically split the signal in order to serve multiple users.

Improving system cost and/or performance typically calls for the ability to launch high optical power into the fiber so as to limit the number of cascaded EDFAs or other amplifiers required to meet the required optical link power budget and to increase the power level of the input optical signal into each EDFA to reduce system noise.

However, as the optical signal propagates in the core of the optical fiber, local electric fields interact with the fiber material leading to noise that limits the maximum optical power that can be launched into the fiber. These nonlinear fiber effects are well known in the art and are typically found to become worse as the length of fiber link is increased. Also, it is known that these nonlinear fiber effects typically become worse the narrower the linewidth of the optical source.

Analog transmitters commonly used for CATV include directly-modulated distributed feedback (DFB) lasers or externally modulated sources (continuous wave (CW) DFB in combination with an external modulator). For digital transmitters, direct-modulated DFBs, electro-absorptive modulated lasers (EMLs) and externally modulated sources are widely deployed. External-cavity lasers (ECLs) represent a new class of lasers being commercialized for both digital and analog applications. ECLs offer several advantages when used under conditions of direct modulation as compared with legacy transmission lasers, including low chirp (low variation of frequency with laser drive current). One characteristic of ECLs is narrow linewidth, which typically exacerbates the nonlinear fiber effects.

Among the most important nonlinear effects in standard SMF at high levels of launched optical power are Stimulated Brillouin Scattering (SBS), MultiPath Interference(MPI)-intensity noise, Self-Phase Modulation (SPM). SPM is the result of the modulation of the refractive index of the optical fiber due to the presence inside the fiber of a high-power amplitude modulated optical carrier signal. SPM may limit the maximum optical power that can effectively be launched into the fiber.

SBS results from a nonlinear optical-acoustic interaction inside single mode fibers and can also limit the maximum amount of optical power that can effectively be launched into the fiber. SBS is typically observed to occur when the light launched into the fiber exceeds a threshold power level, usually around 6-7 dBM in standard SMF at 1550 nm wavelength. A high optical density in the fiber, such as that produced by launching a high-power narrow linewidth laser beam, creates acoustic phonons, which can reflect the optical signal inside the fiber leading to increased attenuation and noise in the optical signal. When the launched power exceeds the SBS threshold, the optical power exiting the far end of the fiber link becomes sub-linear with increased power input into the fiber. One way SBS has been characterized is to refer to SBS linewidth whereby optical scattering is dominated by the amplitude of the optical signal within the SBS bandwidth of about 20-30 MHz (for example see U.S. Pat. No. 6,252,693 and the articles: S. Wu, et al, “Theoretical and Experimental Investigation of Conversion of Phase Noise to Intensity Noise by Rayleigh Backscattering in Optical Fibers,” Applied Physics Lett., Vol. 59, No. 10, pp. 1156, September 1991, and T. E. Darcie, et al, “Fiber-Reflection Induced Impairements in Lightwave AM-VSB CATV Systems,” J. Lightwave Tech., Vol. 9, No. 8, pp. 991, August 1991). For long-reach or highly-branched fiber links, it is important to increase the SBS threshold so that a high level of optical power can be launched into the fiber.

ECLs typically have (in the absence of direct modulation) CW linewidth between about 50 kHz and about 300 kHz depending on such factors as on the designed-for applications, the operating conditions and optical power. Under direct modulation, the CW linewidth of ECLs is typically broadened due in part to the presence of ECLs adiabatic chirp (FM modulation) and the linewidth becomes dynamic. However the extent of dynamic linewidth broadening and its uniformity (distribution of modulating harmonics due to the FM modulation) is typically much smaller in such ECLs compared with existing high-chirp DFB lasers. A high optical density in the fiber, such as that produced by launching a high-power narrow linewidth laser beam, generates acoustic phonons which can scatter the optical signal inside the fiber leading to increased attenuation and noise in the optical signal. When the launched power exceeds the SBS threshold, the optical power exiting the far end of the fiber link becomes sub-linear with increased power input into the fiber. For long-reach or multiple-branched fiber links, it is important to increase the SBS threshold so that a high level of optical power can be launched into the fiber.

Another important source of noise is so-called multipath interference (MPI)-intensity noise caused by spurious multiple reflections creating interferometer in the fiber. Such multiple reflections can be discrete or distributed by nature of optical fiber. In latter case such effect called Double Rayleigh Scattering (DRS). These interferometers convert phase noise into intensity noise and are the source of fiber optic relative intensity nose (RIN). Such intensity noise proportional inverse proportional to the dynamic (or CW) laser linewidth.

The major difference between SBS and MPI effects in lasers is that the first is a non-liner effect and has a threshold behavior while DRS is always present even above SBS threshold.

However, even small amounts of SBS-type noise present in a linear laser (intended to use for broadcast or digital transmission) can have a devastating effect on harmonic distortion and is to be avoided.

In ECLS, DRS typically produces up-conversion of low-frequency interferometer noise into high-frequency noise concentrated near the RF carriers. Such effects can cause saturation of CNR and additional CTB degradation in optical fibers and require additional RF power to suppress DRS noise by increasing the dynamic linewidth beyond the requirements of being above SBS threshold

Depending on the distribution of RF carriers and their bandwidth (broadcast-78 channels, broadcast-110 channels, digital format such as QAM with 16 or 32 channels) and length of fiber link SBS and DRS noise can be suppressed partially or completely. For example, under direct broadcast (78 or 110 channels) modulation SBS threshold of ECL is approximately 14-15 dBM and DRS noise is suppressed almost completely over the distance ˜20 km, however at the expense of the excessive RF power (typically increased by about by 1-2 dB) into the laser

It is important to note that, because of the above mention reasons, requirements for launching very high power into single mode fiber with directly-modulated ECLs as a source dictate not only increasing SBS threshold but also increasing dynamic linewidth beyond requirements to suppress SBS noise such that fiber RIN becomes very small.

Other noise effects generated in fiber links are typically caused by optical feedback due to localized reflectors (typically arising from discrete components such as connectors and splices) or distributed reflection from Rayleigh backscattering within the fiber. Optical feedback causes degradation in the quality of signal generated from the light source. This degradation becomes more severe if a portion of the reflected signal is reflected a second time (typically due to the existence of either discrete and/or distributed reflectors), thus leading to interferometric noise generation as the twice-reflected wave may interfere with the directly transmitted wave.

The conventional approach to increasing the SBS threshold is to spread the transmitted optical spectrum outside of the SBS bandwidth of typically about 20-30 MHz. Several techniques for reducing the nonlinear fiber effects have been reported in the prior art and commercially exploited, but the bulk of these techniques apply to either DFBS (i.e., U.S. Pat. No. 5,453,868) or externally modulated sources (i.e., U.S. Pat. No. 6,252,693) and may not be viable for ECLs. U.S. Pat. Nos. 6,661,814 and 6,661,815 describe techniques for SBS suppression for wavelength-tunable ECLs whereby the external feedback mechanism of the laser cavity comprises a free-space optical beam reflecting from a reflector or retro-reflector and where the output side of the laser is defined by a partially reflective facet of the semiconductor gain element chip.

A commonly used SBS suppression technique is based on dithering of the transmitted optical signal by superimposing a varying electrical signal onto the input RF drive signal to the laser (for the case of a direct-modulated laser as in U.S. Pat. Nos. 5,453,868 and 5,430,569) or to the phase modulator (for the case of an externally-modulated transmitter as in U.S. Pat. Nos. 6,252,693 and 6,535,315). Typical examples of the RF dithering signal include a sine wave at one or multiple frequencies differing from those used for CATV transmissions (typically in the 1.8-2.4 GHz range). This dithering technique has been widely used in DFB-based analog transmitters, where the non-dithered laser linewidth in typically 1-3 MHz. Applying this technique to narrow linewidth lasers FBG-based ECLs (as shown in FIG. 2) has been demonstrated by the inventors to work satisfactorily for a relatively low SBS suppression threshold, typically below about 17 dBm of launched power, but achieving higher SBS suppression thresholds (say, above about 20 dBm of launched power) may require an optical modulation index (OMI) large enough to cause undesirable “compression”, leading to adverse effects on laser performance. Applying a low frequency dithering signal (typically about 10 s of kHz) is not considered to be disadvantageous because (i) the appearance of a heterodyning effect, and (ii) in some cases the elimination of applied dithering from the transmitted optical signal after it emerges from an optical amplifier (EDFA).

Thus, a need exists in the art for improved techniques to increase SBS threshold, such that a high level of optical power can be launched into an optical fiber transmission system.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings, in which:

FIG. 1 is a schematic depiction of an ECL having (a) a grating written in the core of a single mode fiber waveguide, and (b) a grating written on a planar lightwave circuit.

FIG. 2 is a schematic depiction of an ECL including temperature control element.

FIG. 3 is a graphical depiction of laser linewidth and broadening effects.

FIG. 4 is a schematic depiction of microbending applied to a fiber in the lateral direction.

FIG. 5 is a schematic depiction of microbending applied to a fiber in the vertical direction.

FIG. 6 is a schematic depiction of microbending applied to both sides of a fiber: (a) top or side view. (b) end view.

FIG. 7 is a schematic depiction of ECL broadening by application of an electrical signal to a piezoelectric transducer material: (a) top or side view, (b) end view.

FIG. 8 is a schematic depiction of electrical signals applied to a thermal coating on the FBG.

FIG. 9 is a schematic depiction of linewidth broadening for SBS suppression by thermal dithering.

FIG. 10 is a schematic depiction of an FBG-ECL with a built-in level of birefringence.

FIG. 11 is a schematic depiction of SBS suppression with an external phase modulator.

FIG. 12 is a graphical depiction of CW lineshape of a low-chirp ECL, as obtained by a self-delayed heterodyning technique.

FIG. 13 is a graphical depiction of linewidth broadening under an applied dithering signal.

FIG. 14 is a graphical depiction of an example SBS noise behavior without FBG dithering.

FIG. 15 is a graphical depiction of an example SBS noise behavior with FBG dithering.

FIG. 16 is a graphical depiction of linewidth broadening by application of an electrical signal to a piezoelectric jacket.

### DESCRIPTION OF THE INVENTION

The present invention relates to systems, methods, devices, materials and apparatus for the reduction or suppression of nonlinear fiber effects, especially SBS, when narrow linewidth light sources are used, typically external cavity lasers. The present invention includes analog, digital, and sensing applications, among other applications. However, to be concrete in our descriptions, we focus herein on analog applications such as CATV networks, not thereby excluding other applications or limiting the invention to just those embodiments disclosed. Also, the various embodiments of the invention described herein apply for both continuous wave (CW) and direct modulated ECLs. However, the emphasis in describing the embodiments will be on direct analog modulated ECLs. The proposed invention advances the state of the art in the suppression of nonlinear effects generated as the optical signal travels through single mode fiber. The techniques for the reduction or suppression of fiber nonlinear effects apply to transmissions around both 1310 nm and 1550 nm wavelength regions, among others. However we focus in this document on 1550 nm transmission. This field of application is by way of example and not limitation since techniques, processes, devices and materials described herein can find applications in other fields as well.

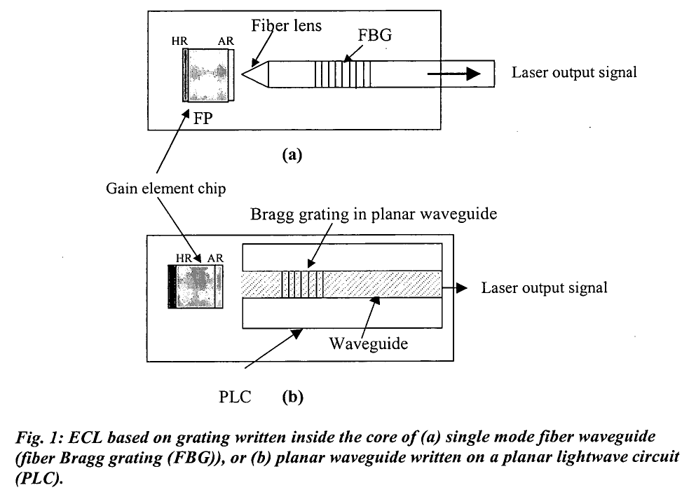

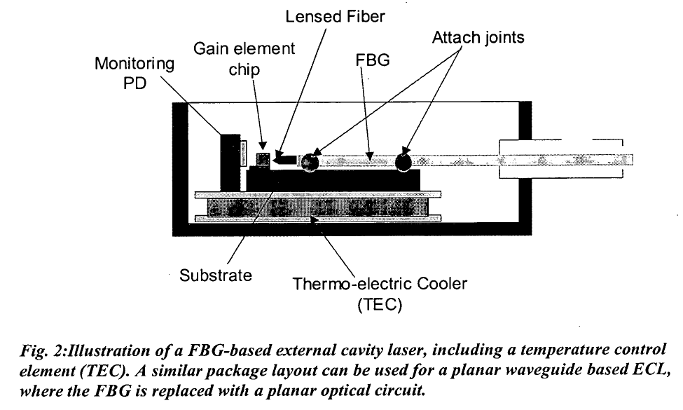

A generalized embodiment of an ECL that may be used to implement some embodiments of the present invention is depicted in FIG. 1. The ECL comprises a laser diode gain element chip, typically having one side coated with an anti-reflective (AR) film in combination with an optical element which can be represented by an optical transfer function, F(λ). The optical transfer function, F(λ), is usually a grating, sometimes referred to as a Bragg grating, and behaves effectively as a wavelength-selective mirror. A portion of the light energy impinging on the grating is reflected back towards the gain element chip and the remaining energy is transmitted through the grating and collected inside the fiber as the laser's output signal. The grating can be formed inside the core of a waveguide such as an optical fiber (thus referred to as a fiber Bragg grating (FBG), or a planar waveguide formed on a planar lightwave circuit (PLC). The laser light is generated within the optical cavity formed by the reflective (or highly reflective-HR) side of the laser diode that is not AR-coated and the Bragg grating. Since the operating wavelength is a sensitive function of temperature, it is a known practice to provide temperature sensing and temperature controlling devices in the module package to maintain a narrow range of operating temperatures (say on the order of 15-30° C.) within the module package environment. A widely used cooling device is a thermoelectric cooler (TEC). This is illustrated in FIG. 2.

The present invention also relates to techniques and methods for reducing or suppressing the fiber-induced noise due to SBS and DRS in analog transmission while preserving the performance advantages of low-chirp Bragg-grating ECLs. The methods include both intra-cavity and extra-cavity linewidth broadening techniques.

Properly designed ECLs can exhibit excellent performance under direct analog modulation including, for example: (i) low second and third order harmonic distortion, (ii) low chirp, (iii) excellent wavelength stability for wavelength division multiplexing (WDM), (iv) low relative intensity noise (RIN), and (v) large laser modulation bandwidth. Some of these performance characteristics are the result of the narrow linewidth nature of ECLs. For instance, FBG-based ECLs having linewidths less than about 100 kHz (typically an order of magnitude smaller than that of DFBs) have been reported by the inventors. The narrow linewidth and low chirp nature of ECLs translate into more severe nonlinear effects in the fiber (especially at distances greater than about 15km), especially SBS and Rayleigh backscattering. Such nonlinear fiber effects can lead to link performance degradation, particularly reduced carrier-to-noise ratio (CNR) and increased harmonic distortion (typically 2^{nd} and 3^{rd} order).

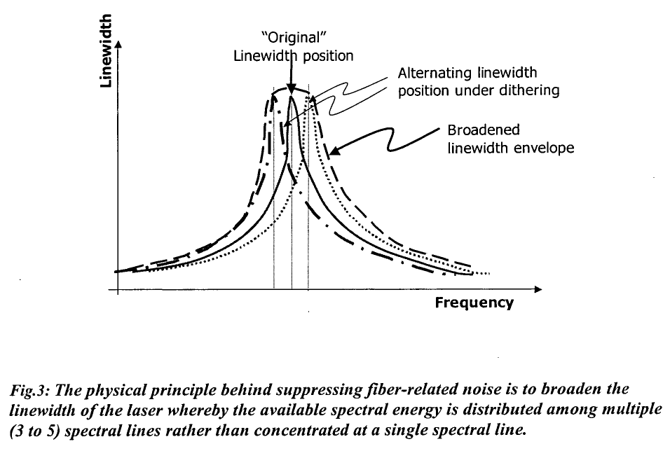

The physical principle behind suppressing primary SBS and secondary Rayleigh backscattering is to broaden the linewidth of the laser whereby the available spectral energy is distributed among multiple spectral lines rather than concentrated at a single spectral line as illustrated in FIG. 3.

The present invention relates to techniques and methods for reducing or suppressing the fiber nonlinear effect in analog transmission while preserving the performance advantage of narrow linewidth Bragg-grating based ECLs. The methods described include both intra-cavity and extra-cavity linewidth broadening techniques. A common feature among these SBS and secondary Rayleigh backscattering suppression techniques is the underlying physical principle of broadening the linewidth of the laser as illustrated in FIG. 3.

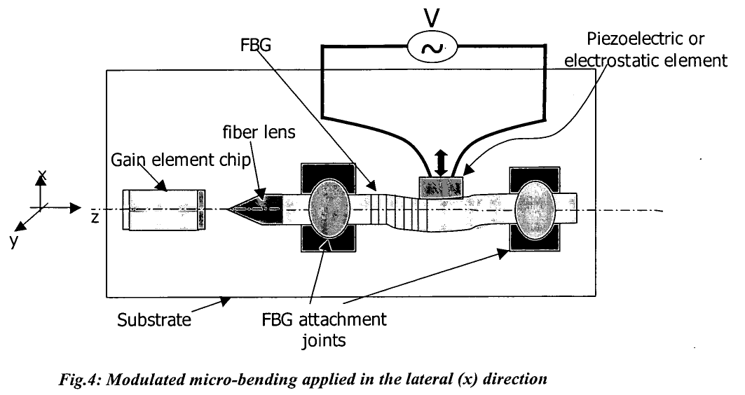

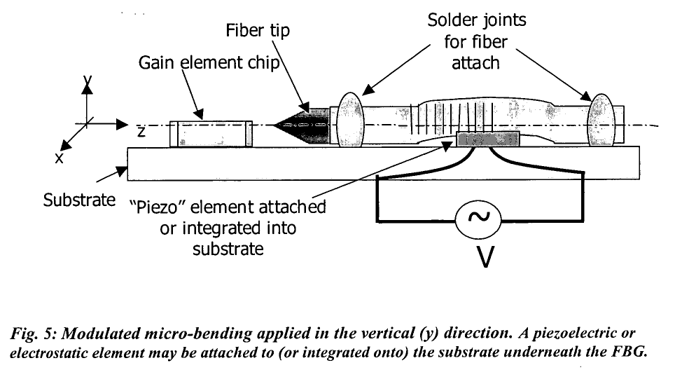

One aspect of the invention for suppressing SBS and double Rayleigh backscattering in FBG-based external cavity lasers relates to the modulation of the refractive index of the FBG by applying a modulated electrical signal to a piezoelectric transducer or to an electrostatic element placed adjacent to the FBG. The modulated stress on the FBG caused by the piezoelectric transducer or an electrostatic element induces micro-bending causing a modulation of the refractive index of the FBG and the creation of a weak birefringence in the FBG, leading in turn, to a broadened linewidth of light passing through the FBG and emitted from the ECL. One embodiment of this method is to attach one piezoelectric transducer or an electrostatic element on one side of the FBG as illustrated in FIG. 4. Another embodiment is to attach to (or integrate onto) the substrate one piezoelectric transducer or an electrostatic element underneath the FBG by as illustrated in FIG. 5. The piezoelectric transducer or an electrostatic element may be used on or off its resonance peak. Damping of unwanted resonances (especially mechanical ones caused by the attachment of a piezoelectric transducer or an electrostatic element) can be achieved by applying proper epoxy or other adhesive material.

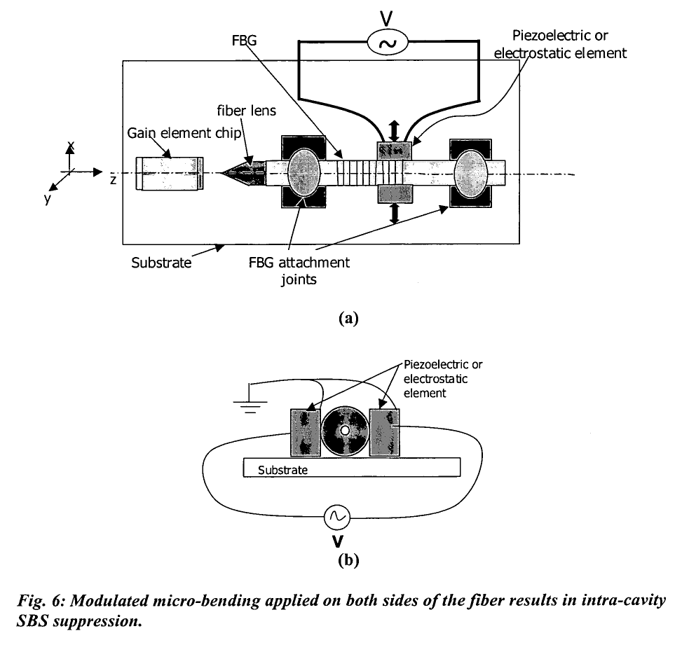

Another embodiment of the intracavity method for suppressing SBS and Rayleigh backscattering is to attach one piezoelectric transducer or an electrostatic element on each side of the FBG as illustrated in FIG. 6. This causes the FBG to be periodically “squeezed” as a sinusoidal electrical signal is applied.

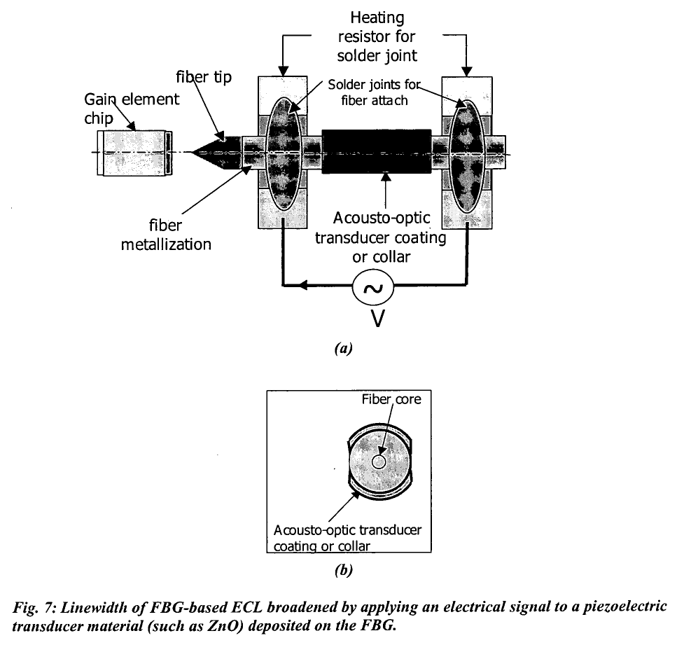

Another embodiment of the intracavity method for suppressing SBS and Rayleigh backscattering in FBG-based ECLs is to deposit a layer of piezoelectric transducer material around the section of the fiber containing the FBG as illustrated in FIG. 7. Piezoelectric coating on the FBG can be applied over different areas of the FBG (such as over 180° or 360° of the fiber surface) depending on the amount of linewidth broadening required and the desired operating frequency. Typical piezoelectric materials include, but are not limited to the following: ZnO, lithium niobate, tellurium oxide, as well as piezoelectric plastics such as polyvinylidine fluoride (PVDF), as well as its derivatives and copolymers.

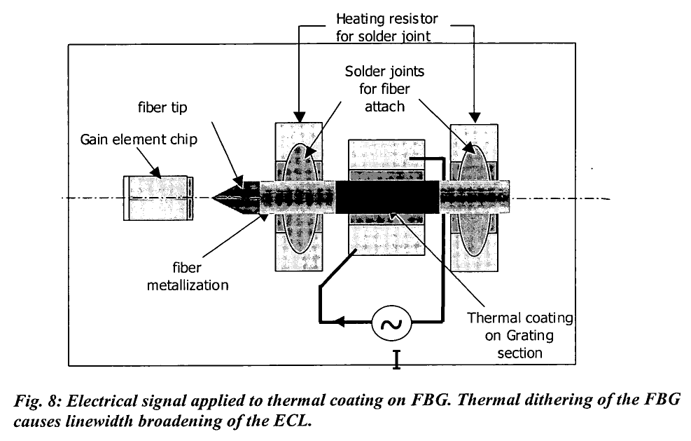

Another embodiment of the intracavity method for suppressing SBS and Rayleigh backscattering in FBG-based ECLs is to deposit a layer of thermally conductive material such as polymeric thick film materials, Kapton™, among others around the section of the fiber containing the FBG as illustrated in FIG. 8. Applying an alternating electrical current through the coated FBG leads to a thermal dithering of the lasing wavelength, thus resulting is spectral broadening of the ECL output.

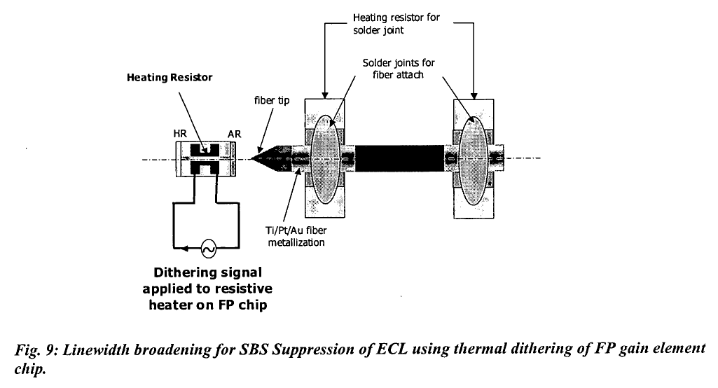

Another aspect of the invention relates to incorporating thermal heaters on or near the active waveguide of the gain element used in building the ECL, as illustrated in FIG. 9. Modulating the current applied to the heaters on the gain element chip with a dither signal leads to a thermal component appearing in the active region This technique may be used alone or as an additional technique to the FBG micro-bending methods described above.

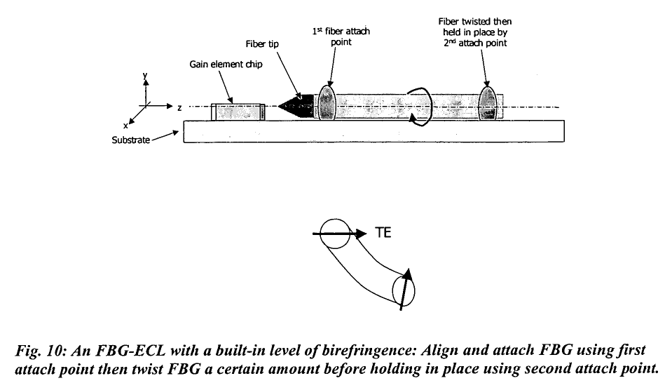

Another method for enhancing the efficiency of some or all of the linewidth broadening techniques mentioned above is to assemble the FBG section of the ECL under a predetermined level of stress, specifically by twisting the FBG so as to induce higher level of birefringence in the fiber, as illustrated in FIG. 10. This built-in birefringence can then be enhanced by one or a combination of the methods described above.

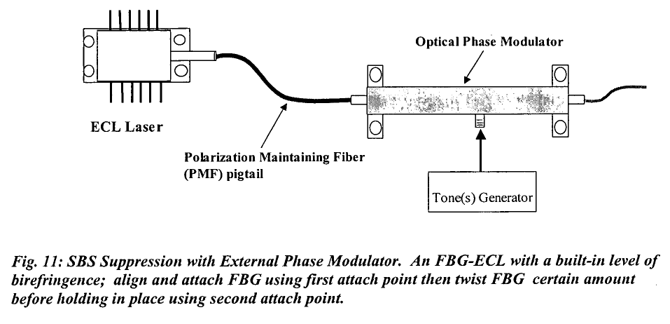

Another aspect of the invention relates to the use of an external phase modulator to broaden the modulated light spectrum. The ECL is built with FBG created inside a polarization-maintaining fiber (PMF). The output power from PMF pigtail in then coupled through a phase modulator as illustrated in FIG. 11. By applying a dither signal to the phase modulator, the linewidth of the laser can be broadened.

The conventional approach to increasing the SBS threshold is to broaden the optical spectrum to a value above the SBS bandwidth (approximately in the range 30-200 MHz) in directly modulated DFBs, (which typically have a time-average spectral width around 500 MHz to 1 GHz), or distributing optical power over a number of RF sub-carriers (externally modulated lasers) by using single tone phase modulation. Such techniques for reducing the nonlinear fiber effects have been reported in the prior art and commercially exploited, but the bulk of these techniques apply to either DFBs or externally modulated sources and may not be viable for ECLs. The prior art typically relates to techniques for SBS suppression for wavelength-tunable ECLs whereby the external feedback mechanism of the laser cavity comprises a free-space optical beam impinging on a reflector or retro-reflector and where the output side of the laser is defined by a partially reflective facet of the semiconductor gain element chip.

The present invention relates to techniques and methods for reducing or suppressing the fiber -induced noise due to the SBS and DRS in analog transmission while preserving the performance advantage of low-chirp Bragg-grating based ECLs. The methods described include both intra-cavity and extra-cavity linewidth broadening techniques.

One aspect of the invention for suppressing SBS and Double Rayleigh scattering in FBG-based external cavity lasers relates to the modulation of the refractive index of the FBG by applying a modulated electrical signal to a piezoelectric transducer or to an electrostatic element placed adjacent to the FBG. The modulated stress on the FBG induced by the piezoelectric transducer or an electrostatic element causing a modulation of the refractive index of the FBG and periodical displacement FBG wavelength peak leading to a broadened linewidth of light passing through the FBG and emitted from the ECL.

One embodiment of this method is to attach one piezoelectric transducer or an electrostatic element on one side of the FBG as illustrated in FIG. 4. Another embodiment is to attach to (or integrate onto) the substrate one piezoelectric transducer or an electrostatic element underneath the FBG by as illustrated in FIG. 5. The piezoelectric transducer or an electrostatic element may be used on or off its resonance peak. Special attention (damping) should be pay to the fact that such modulation may cause vibration of the existing gap between FP chip and tip of the lensed fiber due to the distributed mechanical resonance in the ECL package. Residual modulation of such gap, which is the part of total length of ECL cavity, will produce heterodyning effect and harmonic distortion in CATV RF band. Such damping could be accomplished by using combination of hard and soft soldering or reinforcing first soldering joints with another type of damping such as indium type.

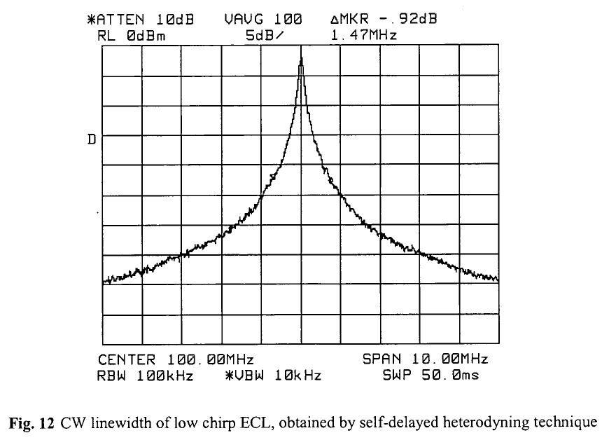

Another embodiment of the intracavity method for suppressing SBS and Double Rayleigh Scattering is to attach one piezoelectric transducer or an electrostatic element on each side of the FBG as illustrated in FIG. 6. This causes the FBG to be periodically “squeezed” as a sinusoidal electrical signal is applied. This embodiment with low chirp ECL (˜20 MHz/mA) was implemented into experimental 14-pin butterfly package, standard for telecom industry. FIG. 12 shows the CW linewidth of low chirp laser.

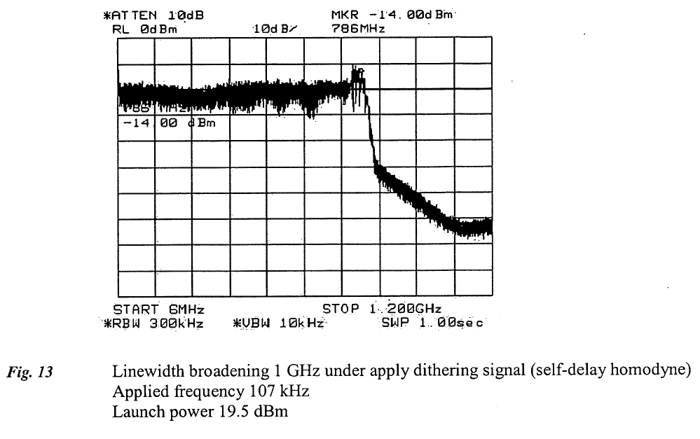

FIG. 13 demonstrates linewidth broadening up to 1 GHz under dithering signal 107 kHz applied from both sides of the FBG to the piezoelectric transducers. Such linewidth broadening allow launch power 19.5 dBM into single mode fiber with completely suppressed SBS noise.

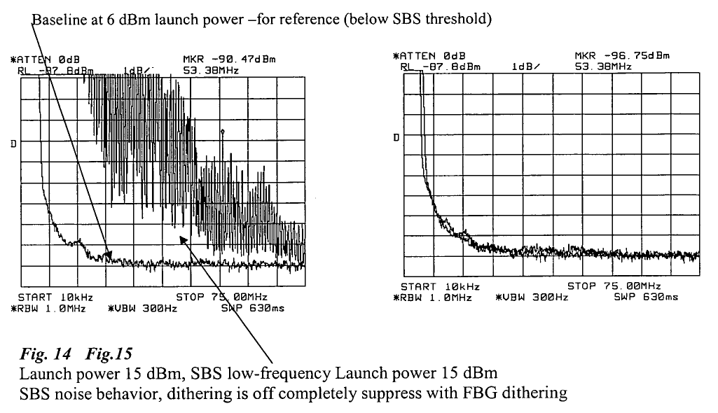

FIGS. 14 and 15 illustrate the effect of SBS induced noise and its suppression with FBG dithering techniques in the low frequency region.

Another embodiment of the intracavity method for suppressing SBS and Double Rayleigh scattering in FBG-based ECLs is to use wide-band piezo-modulation coating to introduce acoustic waves into metallized FBG and periodically modulate refractive index. By doing this it is possible directly affect position of the peak of FBG and correspondingly broadening laser wavelength without introducing direct modulation into laser chip.

The use of a piezoelectric coating as a jacket on the metallized FBG allow reduce of amount RF power require for modulation, considerably increase mechanical stability Because of the micron size thickness of the piezo-coating layer such piezo-transducers offer wide-band RF modulation bandwidth up to 50 MHz which is very important factor in operation of ECLs with SBS suppression technique for broadcast transmission. Typical piezoelectric materials include, but are not limited to the following: PZT, ZnO, PVF₂ VDF/TFE, as well as its derivatives and copolymers.

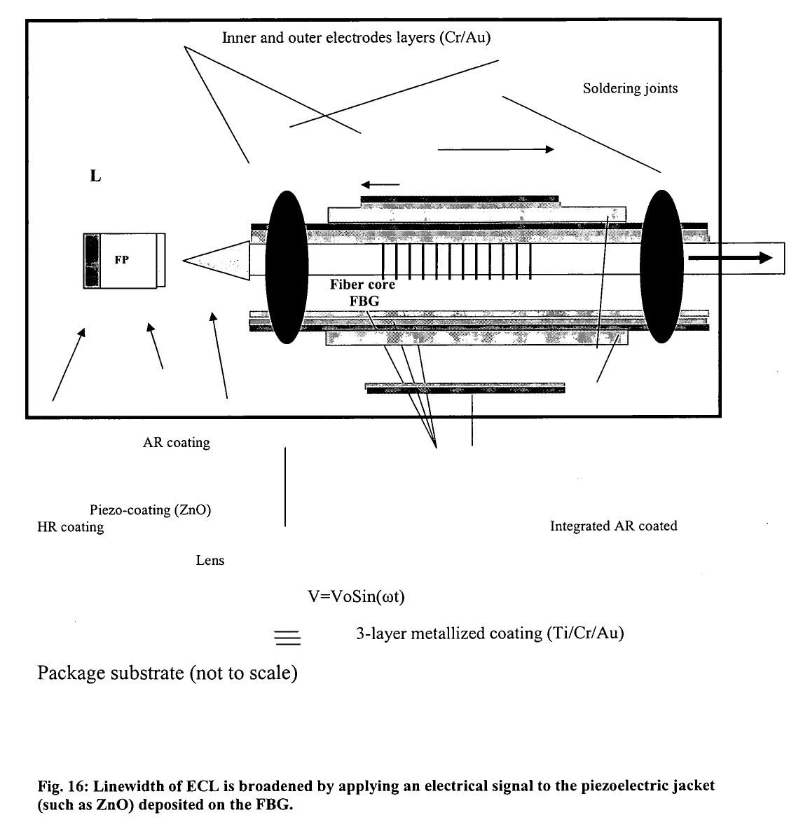

All metallized coating, electrodes and piezo-coating layers can be deposited by reactive dc magnetron sputtering technique. Cylindrical geometry allows the fiber itself to function as an acoustic resonator, creating standing acoustic waves within the region of Bragg grating, where the length of outer electrode will determine length of modulator. FIG. 16 illustrate typical design and operation of ECLs using FBG with piezoelectric film jackets.

Another embodiment of the intracavity method for suppressing SBS and Double Rayleigh scattering in FBG-based ECLs is to deposit a layer of thermally conductive material such as polymeric thick film materials, Kapton™, among others around the section of the fiber containing the FBG as illustrated in FIG. 8. Applying an alternating electrical current through the coated FBG leads to a thermal dithering of the lasing wavelength, thus resulting is spectral broadening of the ECL output.

Another aspect of the invention relates to incorporating thermal heaters on or near the active waveguide of the gain element used in building the ECL, as illustrated in FIG. 9. Modulating the current applied to the heaters on the gain element chip with a dither signal leads to a thermal component appearing in the active region This technique may be used alone or as an additional technique to the FBG micro-bending methods described above.

Another aspect of the invention relates to the use of an external phase modulator to broaden the modulated light spectrum. The ECL is built with FBG created inside a polarization-maintaining fiber (PMF). The output power from PMF pigtail in then coupled through a phase modulator as illustrated in FIG. 10. By applying a dither signal to the phase modulator, the linewidth of the laser can be broadened.

Although various embodiments which incorporate the teachings of the present invention have been shown and described in detail herein, those skilled in the art can readily devise many other varied embodiments that still incorporate these teachings.

What is claimed is:

1. A method of reducing noise in an optical transmission through an optical fiber comprising:
applying modulated stress to the partially reflective element of the optical transmitter so that the transmission characteristics of said partially reflective element change with said modulation, thereby producing an optical output having a broadened output envelope.

2. A method as in claim 1 wherein said stress is mechanical stress applied by one or more piezoelectric transducers.

3. A method as in claim 2 wherein said one or more piezoelectric transducers have locations so as to apply modulated compression to said partially reflective element.

4. A method as in claim 1 wherein said stress is electrostatic stress.

5. A method as in claim 4 wherein said electrostatic stress is applied from locations so as to apply modulated compression to said partially reflective element.

6. A method as in claim 1 wherein said stress is thermal stress.

7. A method of reducing noise in an optical transmission through an optical fiber comprising:
applying modulated thermal stress to the gain element of the optical transmitter so that the gain characteristics of said gain element change with said modulation, thereby producing an optical output having a broadened output envelope.

8. An optical transmitter comprising an active gain element within an optical cavity wherein said optical cavity has a reflective element on one end thereof and a partially reflective element on the other end thereof, further comprising a means for modulating the transmission characteristics of said partially reflective element by applying modulated stress thereto.

9. An optical transmitter as in claim 8 wherein said stress is mechanical stress applied by one or more piezoelectric transducers.

10. An optical transmitter as in claim 9 wherein said one or more piezoelectric transducers have locations so as to apply modulated compression to said partially reflective element.

11. An optical transmitter as in claim 8 wherein said stress is electrostatic stress.

12. An optical transmitter as in claim 11 wherein said electrostatic stress is applied from locations so as to apply modulated compression to said partially reflective element.

13. An optical transmitter as in claim 8 wherein said stress is thermal stress.
